(19) United States
(12) Patent Application Publication
(10) Pub. No.: US 2023/0368005 A1
(43) Pub. Date: Nov. 16, 2023

(54) MODEL OF ACTIVITY IN NEURAL NETWORKS IN SPACE AND TIME

(71) Applicant: Patricia Colleen MacKenzie, North Miami, FL (US)

(72) Inventor: Patricia Colleen MacKenzie, North Miami, FL (US)

(73) Assignee: Patricia Colleen MacKenzie, North Miami, FL (US)

(21) Appl. No.: 18/195,922

(22) Filed: May 10, 2023

Related U.S. Application Data
(60) Provisional application No. 63/340,434, filed on May 10, 2022.

(51) Int. Cl. G06N 3/049

(52) U.S. Cl. CPC G06N 3/049

(57) ABSTRACT

A model of neural networks wherein the fast-spiking class of interneurons regulate network activity in space and time. Fast-spiking neurons regulate activity in neural networks in response to input by providing strong, rapid inhibition to a plurality of excitatory neurons. This limits the number of active neurons in space and time. The calculations performed by cortical neural networks are a harmonic oscillator. Similar to changes in particle energy states, FS neurons shift between discrete developmental states that correspond to the frequency of harmonic oscillations emerging from the model.

### CROSS REFERENCE TO RELATED APPLICATION

This application claims benefit to provisional application 63/340,434 filed on May 10, 2022, of the same name and inventor. The disclosures of the provisional application are incorporated by reference in the disclosures in this application.

### TECHNICAL FIELD

The following relates to modeling neural networks, more specifically modeling the math performed by cortical neural networks.

### REFERENCES

MacKenzie, Patricia, Model of fast-spiking neurons regulating neural networks. Nov. 15, 2019. MacKenzie, Patricia, Universal Consciousness, Xerox PARC dealers of lightening talk series. Mar. 8, 2022.

### BACKGROUND

Artificial intelligence (AI) is informed by biological neural networks. The connectivity of a convolutional neural network (CNN), for example, is modeled after the connectivity of biological neural networks that perceive visual information. Neurons in the human retina are spatially organized according to receptive fields that comprise the visual information they respond to. Receptive fields overlap such that the entire field of vision is represented. Receptive fields span synaptic connections, meaning the receptive field of a photoreceptor is retained in the spatial connectivity of a postsynaptic retinal ganglion cell and thalamic neurons innervating the visual cortex. CNNs use spatial organization and similar layers of connectivity as circuitry of the retina; each layer performs a calculation and outputs that information to the next layer and neurons may pool information between layers. Recent advancements in combining CNNs with the computational power provided by high performance CPUs and GPUs has enabled AI to outperform humans at simple image recognition tasks.

Although deep learning has recently advanced significantly, conceptual understanding of the calculations biological neural networks perform has not comparably advanced. The expectation that AI designed based on subcortical, evolutionarily ancient neural networks like the retina is capable of performing calculations comparable to a conscious form of intelligence may pose unintended negative consequences. The advancement of AI informed by biological neural networks is restricted by lack of understanding of the mathematics that emerges from evolutionarily nascent cortical neural networks.

The following seeks to address the above problems.

### SUMMARY

Discoveries in biology have myriad applications. One application is modeling biological neural networks, translating discoveries into artificial intelligence (AI) that may be applied to making predictions in disparate systems.

In an artificial convolutional neural network (CNN), a bipolar cell is modeled as a pooling layer. CNNs contain exhibit comparable visual processing capabilities as a biological retina, as the structure of biological neural networks reflects the function. By modeling the structure of the retina, CNNs perform similar calculations, which may be applied to visual predictions in systems beyond biological neural networks. The math performed by biological neural networks is experimentally testable. Understanding the calculations performed by biological neural networks provides insight into the calculations performed by AI.

The complex calculations performed by even simple neural networks in the ancient retina are emergent, meaning, the calculations performed by neurons forming the network are beyond the calculations performed by the individual neurons that comprise the network.

The retina is an evolutionary ancient neural network; expression of the developmental master regulator pax6 underlies the formation of all eyes. Neural networks in the cortex likely confer the cognitive abilities that define consciousness, as cortex is an evolutionarily nascent structure unique to mammals.

The invention in this disclosure enables modeling cortical neural networks according to the movement of activity in time and space. In the model provided, FS neurons receive direct input from the environment through thalamic input. Excitatory neurons receive comparatively weak, broad thalamic input and strong inhibitory input from FS neurons. FS neuron mediated inhibition onto a plurality of connected excitatory neurons enables precise regulation of activity in neural networks. FS neuron activity may be used to predict the movement of activity in time and space.

Activity as it moves through cortical space and time can be defined as:

\ddot{x}=ω²x=0.

In the model shown, inhibitory FS neurons regulate activity in space and time according to the following properties:
1. FS neurons are rare yet make significantly more connections with significantly greater weight;
2. FS neurons perform calculations in advance of regulated neurons and uniquely sustain high frequency firing rates.

In cortical neural networks, FS mediated inhibition and excitation are balanced. The regulation of activity in space and time is identified in this disclosure as a harmonic oscillator.

In biological neural networks, FS neurons shift between three discrete maturation states, a biological process underlying developmental experience dependent plasticity and learning and memory in adults. The emergence of harmonic oscillations in the model in this disclosure relates the frequency of harmonic oscillations to the discrete maturation states of FS neurons. Excitation and inhibition maintain balance in each state. The model in this disclosure may be applied to disparate systems that include high energy states. Theoretically, the model in this disclosure enables infinite excitation and infinite inhibition, as these theoretically infinite terms remain balanced.

The details of one or more embodiments of the subject matter of this specification are set forth in the accompanying drawings and the description below. Other features, aspects, and advantages of the subject matter will become apparent from the description and accompanying drawings.

### DESCRIPTION OF DRAWINGS

FIG. 1 illustrates a model of a Hodgkin-Huxley and artificial neuron;

FIG. 2 is an illustrative example of the structure and function of a biological cortical neural network;

FIG. 3. is a representative example of regulated and unregulated synaptic events in biological cortical neural networks;

FIG. 4. illustrates a model of FS neurons regulating activity in space and time in neural networks;

FIG. 5. illustrates the emergence of harmonic oscillations in a model of FS neurons regulating activity in neural networks;

FIG. 6. illustrates a model of FS neurons regulating experience dependent plasticity;

FIG. 7. illustrates the emergence of harmonic oscillations with varying energy states in a model FS neurons regulating activity in neural networks;

FIG. 8. illustrates a model of FS neurons regulating activity in space and time wherein quantum harmonic oscillations are an emergent property.

### DETAILED DESCRIPTION

It is to be understood by those of ordinary skill in the art that, although myriad details are set forth in order to aid understanding of the embodiments described herein, these embodiments may be practiced without these specific details. In other instances, well-known methods, procedures and components have not been described in detail so as not to obscure the embodiments described herein. This description is not to be considered as limiting the scope of the embodiments described herein.

It is to be understand that the following principles generally apply to neural networks and the design of AI based on biological neural networks. Biological neural networks inform the architecture of artificial intelligence, including but not limited to artificial neural networks and Bayesian probabilistic models. As would be known to one skilled in the art, biological neural networks may be translated into artificial neural networks in myriad ways. As in biological retinal neural networks, a simple CNN may vary in the configurations which may include and is not limited to the methods of instantiation on on or more processors.

Biological neural networks are comprised of neurons that are connected electrochemically through synapses or gap junctions. In biological neural networks, this definition may be expanded to additional forms of connectivity, including and not limited to small molecules like growth factors released across synapses and the contribution of immune cells and receptors, including and not limited to microglia. It should be understood that biological neural networks are comprised of very large numbers of neurons with myriad complex configurations and the models provided are anatomically representative illustrations. Network layers are represented in this model in temporal order, as information originating from the environment relayed to cerebral cortex (cortex), not as anatomically ordered cortical layers unless otherwise specified. In biological neural networks, connection weight is defined by the change in resting membrane potential in a postsynaptic neuron typically as the opening of receptors; weight reflects contribution of a synaptic event to the probability of a neuron firing an action potential. Connection weight can include and is not limited to the contribution of gap junction; the FS class of interneurons are electrically gap junction coupled to neighboring FS neurons, forming a regulatory network that spans cortex.

In biological neural networks, FS neurons are nonsomatostatin expressing cells of medial ganglionic eminence origin and may be identified throughout postnatal development in mice using line G42 (GAD67-EGFP transgenic strain G42). In this disclosure FS neurons are defined by their developmental origin rather than the marker parvalbumin, which inconsistently labels a subset of FS neurons. As would be known to one skilled in the art, cell types shown here may contain subpopulations of neuronal types. For example, chandelier FS neurons in L1 may be classified as a different subpopulation than basket cells in deeper cortical layers. Similarly, excitatory projections neurons in the cortex may be further classified into myriad populations by developmental journey and corresponding properties. As would be known by one skilled in the art, the precise boundaries between cell types is debated; this is true even in neural networks that have been studied in depth for use in modeling neural networks, such as the retina.

Neural networks perform complicated calculations, which emerge from the structure of the network. The structure of biological neural networks reflects the function. By modeling the structure of the retina, CNNs exhibit the same visual processing capabilities, which may be applied to performing visual predictions in systems beyond biological neural networks. Biological models seek to define general mathematical calculations performed by neural networks, for example, the calculations performed by on and off-bipolar neurons in the retina. Understanding the calculations performed by biological neural networks provides insight into the calculations performed by AI.

The retina is an evolutionary ancient neural network; expression of the developmental master regulator pax6 underlies the formation of all eyes. In contrast, neural networks in the cerebral cortex (cortex) likely confer the cognitive abilities that define consciousness, as cortex is an evolutionarily new structure unique to mammals.

It should be understood that the model in this disclosure is a representative model, wherein the specific parameters and uses may be altered. As would be known by one skilled in the art, neural network properties widely vary; the spiking properties and math that define neurons is diverse amongst even individuals and cortical areas.

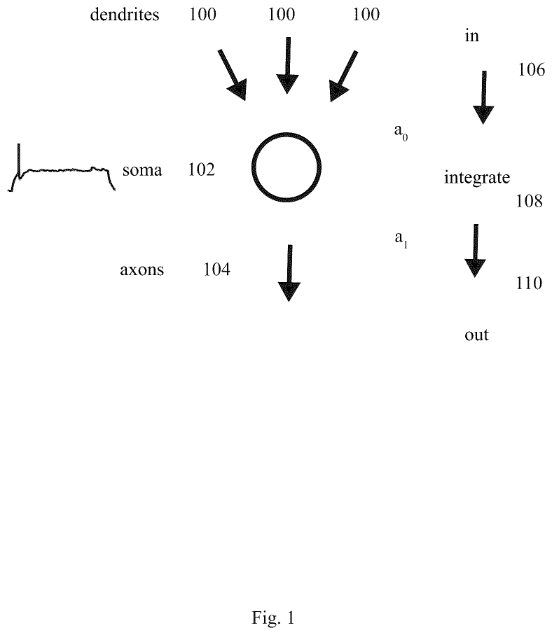

Models of neural networks describe highly dimensional variations using universal mathematics. In reference to FIG. 1, biological neurons integrate dendritic input 100 into binary action potentials 102, which are probabilistic output 104 onto connected neurons as the release of synaptic vesicles. In the neuron shown, complex dendritic calculations are elegantly captured by modeling binary action potentials 102.

Hodgkin and Huxley's four differential equations, derived from the second law of thermodynamics and Ohm's law, form the basis of early and modern models of biological neural networks. Hodgkin and Huxley reduce dendritic complexity to binary action potentials by modeling K+ channels opening and closing through a series of four differential equations. Hodgkin and Huxley experimentally validated this model in a giant squid axon, recording an action potential for the first time. As would be known to one skilled in the art, the physiological activity of biological neural networks are traditionally modeled using myriad methods including and not limited to traditional Hodgkin and Huxley, the Goldman-Katz equation, leaky integrate and fire, oscillate and fire, or derivations or combinations therein. Modern models additionally incorporate probabilistic noise, for example Gaussian noise distributions, and, as would be known by a skilled practitioner, probabilistic noise may be modeled in myriad ways.

Models of biological neurons may be further abstracted. Hodgkin and Huxley's approach of reducing probabilistic input to a prediction of the binary integration of inputs may be further abstracted to an artificial neuron. An artificial neuron receives one or more inputs 106 from connected neurons in the proceeding layer in the form of an activation function, and similarly performs a calculation 108 and outputs 110 the result in the form of an activation function that serves as input to connected neurons in a proceeding layer. Although the calculation performed by an artificial neuron are often distinct from the calculations performed by biological neurons, the structure of biological neurons and neural networks are often retained. As would be known by one skilled in the art, layers in artificial neural networks are generally matrixes or vectors and denote the sequential order of calculations.

Biological models seek to define general mathematical calculations performed by neuron and neural networks, for example, the calculations performed by on and off-bipolar neurons in the retina. The neuron shown may be a bipolar cell, which integrates input 100 from multiple photoreceptors, performs a calculation in the form of an action potential 102, and this calculation becomes synaptic input 104 onto connected retinal ganglion cells. Neural networks that form the retina perform complicated calculations, which emerge from the structure of the network. In biological neural networks, predictions made by models are experimentally validated. The calculations performed by simple and complex neurons in primary visual cortex may be tested experimentally, enabling the validation of theory in biological neural networks. In one example, it is known that bipolar neurons are linear processors, as this hypothesis was experimentally validated by recording biological neurons in carefully designed experimental conditions.

In an artificial convolutional neural network, a bipolar cell is modeled as a pooling layer. CNNs contain exhibit comparable visual processing capabilities as a biological retina, as the structure of biological neural networks reflects the function. By modeling the structure of the retina, CNNs perform similar calculations, which may be applied to visual predictions in systems beyond biological neural networks. The math performed by biological neural networks is experimentally testable, and may be used to understand the untestable calculations performed by AI and applied to disparate, nonbiological systems.

The complex calculations performed by even simple neural networks in the ancient retina emerge from the structure of the network. Emergent properties or mathematical calculations in this context is generally defined as calculations performed by neural networks, beyond the calculations performed by the individual neurons that comprise the network. The retina is an evolutionary ancient structure as defined by evolutionary development; all eyes are fated by the highly evolutionarily conserved master regulator Paired box protein 6 (Pax6). The cerebral cortex, referred to as cortex in this disclosure, is an evolutionarily nascent structure unique to mammals. Neural networks in the cortex likely confer the cognitive abilities that define consciousness. Modeling cortex enables understanding intelligence that is unique to mammals, including and not limited to human cognition.

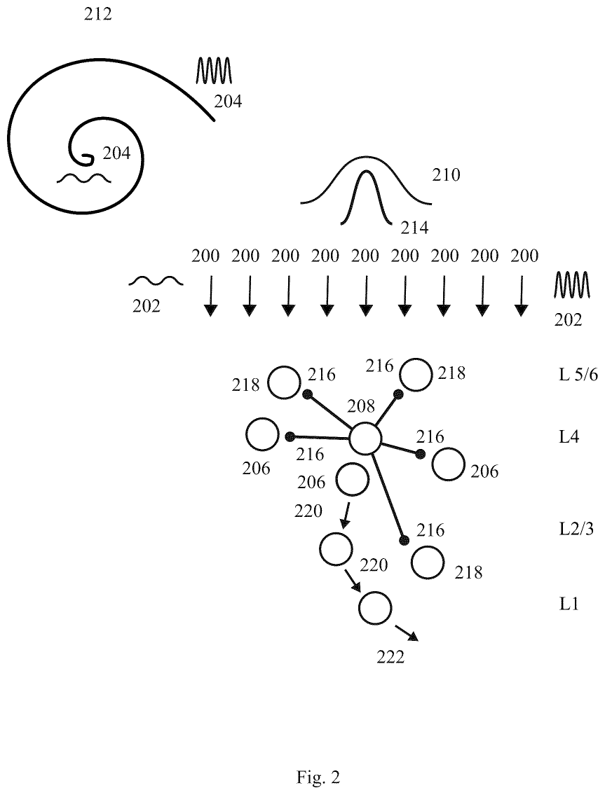

In reference to FIG. 2, cortical neurons receive thalamic input 200 with organization 202 that reflects the topographical organization of information relayed from the external environment 204. Thalamic afferents 200 innervate excitatory neurons 206, mainly layer 4/5 excitatory cells, and FS interneurons 208. In primary auditory cortex in mice, for example, excitatory neurons 206 are broadly tuned 210, meaning, excitatory neurons are innervated by multiple thalamic inputs 200 that relay sensory information corresponding to multiple hair cells in the cochlea 212, and thus fire in response to a range of sensory information.

FS neurons 208 generally receive thalamic input 200 corresponding to one hair cell in the cochlea 212 and are thus narrowly tuned 214. FS neurons locally inhibit 216 many excitatory neurons 206, 218. FS neurons rarely inhibit excitatory neurons that respond to the same input (within −50 nm), and instead more generally inhibit excitatory neurons in multiples layers that correspond to adjacent tones in a tonotopic map. The structure of this neural network increases acuity in auditory perception, as it enables lateral inhibition and co-tuning.

The majority of neurons in the cortex are excitatory neurons, which are connected 220 to cortical neurons in addition to myriad subcortical brain areas 222. Excitatory neurons in both superficial and deep layers receive local input from cortical neurons and long range input and output to local neurons and long range connections, and additionally may be connected to a diversity of interneurons. In cortex, similarly to evolutionarily ancient neural networks like the retina, excitatory neurons and the majority of interneurons are fated during early development, in the absence of sensory experience originating from the external environment.

Spontaneous activity initiated by developmental programs determines the cell fate and subsequent maturation, meaning, the distinct connectivity and distinct action potential firing properties that define the majority of cell types are genetically encoded. In cortex, similarly to evolutionarily ancient neural networks like the retina, the majority of neurons are fated during early development, in the absence of sensory experience originating from the external environment. Spontaneous activity initiated by developmental programs determines the cell fate and subsequent maturation, meaning, the distinct connectivity and distinct action potential firing properties that define the cell type are genetically encoded. The structure then is generally defined as innate in function. In one example, baby mice vocalize many days prior to hearing onset, as language begins as an innate behavior.

Cortex is unique, in that genetically encoded cortical neural networks may acutely change, reflecting experience relayed as thalamic input in the structure and function of cortical neural networks. This biological process is defined as experience dependent development. As described previously, the maturation of FS neurons is uniquely experience dependent. FS neurons uniquely require thalamic input to form mature connections; significantly reducing activity selectively prevents the maturation of FS neurons.

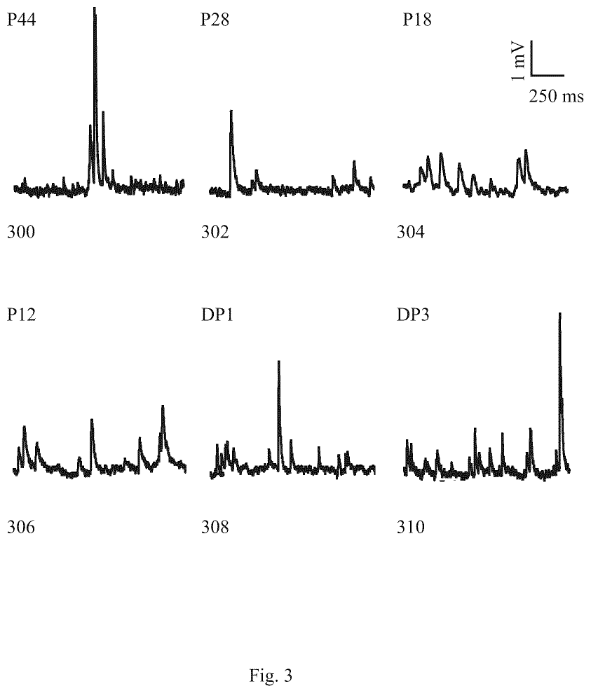

In reference to FIG. 3, selective removal of FS mediated inhibition results in significantly higher rates of spontaneous activity in neural networks. In the representative image shown, recordings of excitatory activity (EPSPs) were recorded in cortex at varying developmental ages, in adults 300 and 302, and during experience dependent development, 304 and 306. The representative images demonstrate a significant increase in excitatory events, 308 and 310, in response to selective decreases in thalamic input, which acutely impairs FS mediated inhibition. This finding was consistently observed in cell types and layers throughout the cortical area that received a selective decrease in thalamic input. This finding is inconsistent with the homeostatic plasticity model wherein a decrease in thalamic activity would predict a comparable decrease in activity in cortical neural networks.

As described previously, FS neurons require activity to form connections, as retracting and reforming connections is a natural aspect of their development. In the absence of FS mediated inhibition, small amplitude EPSPs significantly increase and large amplitude events significantly decrease. This finding is consistently observed in FS neurons and excitatory neurons. Frequent, small amplitude EPSPs are indicative of uncoordinated activity and stochastic neurotransmitter release from excitatory neurons, which resembles gaussian noise.

Excitatory neurons are connected to neighboring neurons and make long range connections. In the absence of FS mediated inhibition, spontaneously active excitatory neurons spread activity over space and time. This is consistent with the findings that loss of functional FS neurons results in cortical neural networks that are vulnerable to seizures and related neurological disorders.

Neural networks in biological systems contain a large number of possible connections; FS neurons restrict activity in otherwise highly active cortical neural networks.

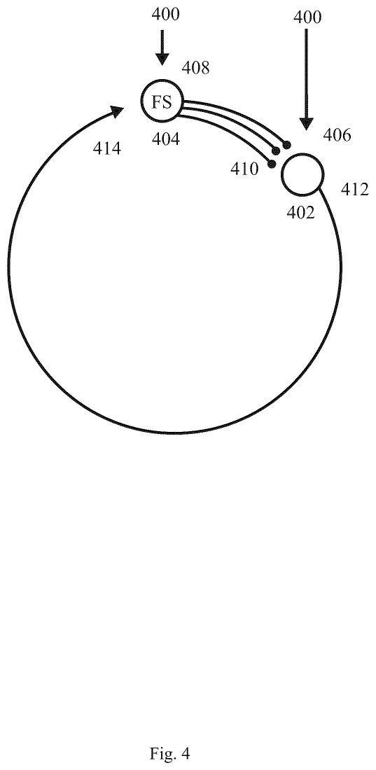

Referring now to FIG. 4, a model wherein FS neurons regulate activity in time and space in neural networks. As previously described, thalamic afferents 400 innervate excitatory 402 and FS neurons 404. Excitatory neurons require summation of multiple excitatory synaptic inputs in order to fire one or more action potentials, typically integrating input from neighboring neurons and disparate cortical and subcortical neural networks in addition to thalamic input 406. Excitatory neurons form the majority of neurons in the brain. As described previously, excitatory neurons may be subdivided into many classes, and are typically subdivided by their location in cortical space and connectivity which reflects developmental fate maps. As would be known by one skilled in the art, the majority of neurons in the cortex are excitatory projection neurons, meaning, excitatory neurons that are connected to cortical neurons in addition to myriad subcortical brain areas. Excitatory neurons form complicated and variable neural networks, connecting to local excitatory neurons spanning multiple cortical layers and a diversity of nonFS interneurons in addition to projecting to multiple neural networks.

FS neurons 404 receive strong and rapid synaptic input 408 from the thalamus 400; one event at a thalamus-FS synapse is sufficient to result in an FS neuron firing one or more action potentials. FS neurons rapidly inhibit 410 a plurality of local excitatory neurons in multiple cortical layers. FS mediated synaptic events are characterized by high amplitude and rapid kinetics and perisomatic localization, which is typically sufficient to prevent postsynaptic neurons from firing one or more action potentials. FS neurons significantly restrict activity in the cortex to a small number of active excitatory neurons, which may then excite connected 414 local excitatory and inhibitory neurons and make long range connections 412 to other brain areas. While FS neurons are local regulators, regulating activity in the cortex regulates the integration of cortical neurons with distant brain areas.

FS neurons locally restrict the spread of activity in space and time. FS inhibition to excitatory neurons prevents neurons that are weakly or indirectly activated by thalamic input to integrate and fire action potentials, restricting activity to a small number of local excitatory thalamic targets that summate multiple excitatory events during a brief window of excitation.

Cortical FS neurons are rare, comprising approximately 4% of neurons in the cortex, yet constitute the majority of inhibition in the cortex, forming 100 or more times as many synaptic connections as excitatory neurons. FS neurons are electrically gap junction with nearby FS cells, forming an electrically gap junction coupled intricate network within cortical neural networks. FS neurons may additionally be activated by excitatory neurons 414, and may recurrently inhibit excitatory neurons 410.

Activity as it moves through cortical space and time can be defined as:

\ddot{x}=ω²x=0.

In the model shown, inhibitory FS neurons regulate activity in space and time according to the following properties:
1. FS neurons are rare yet make significantly more connections with significantly greater weight;
2. FS neurons perform calculations in advance of regulated neurons and uniquely sustain high frequency firing rates.

In cortical neural networks, FS mediated inhibition and excitation are balanced. As would be known by one skilled in the art, balanced inhibition and excitation may be modeled using physiological properties using myriad methods, including and not limited to using the Goldman-Katz equation to inhibition and excitation.

In the model shown, the weight and connectivity (a_{fs}) of one or more FS neurons (n_{fs}) is balanced by the comparably large number of excitatory neurons (n_{pc}) and active in space and time and corresponding excitatory connectivity and weight (a_{pc}), or:

(n_{fs}*a_{fs}0+(n_{pc}*a_{pc})=0

Defining the variables of time and space in neural networks by regulation of FS neurons reduces these variables to measurable and computationally elegant variables, as only FS activity in relation to input needs to be known to predict the movement of activity in space and time and thus the structure and function of the neural network. While FS neurons are local regulators, regulating activity in the cortex regulates the integration of cortical neurons with distant brain areas.

This model allows for myriad variations for differing networks, as connectivity to local neurons including and not limited to other classes of interneurons and excitatory connectivity can vary within this model depending on which neurons are regulated by FS neurons and how these neurons are connected within networks that may span throughout the brain.

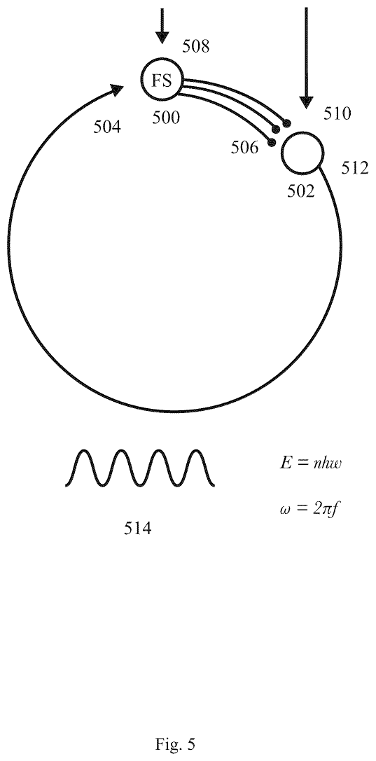

In reference to FIG. 5, FS neurons initiate high frequency synchronized oscillatory activity in neural networks. FS neurons 500 are reciprocally connected to excitatory neurons 502, meaning, FS neurons receive excitatory input 504 from the same excitatory neurons they inhibit 506. For simplicity, in this disclosure reciprocally connected is defined by the approximate locations in cortical space wherein FS neurons inhibit excitatory neurons and excitatory neurons excite FS neurons.

FS neurons 500 inhibit 506 excitatory neurons 502 in response to thalamic input 508, limiting activity to a subset of excitatory neurons that receive thalamic input 510 of similar origin and are thus not inhibited by FS neurons. Reciprocal connectivity enables FS neurons to regulate activity in space and time, as active neurons activate neighboring neurons 512, which activate FS neurons 504, resulting in inhibition 506. These properties enable FS neurons to coordinate activity by regulating activity in space and time, or the emergence of oscillatory activity 514. The movement of activity in space and time in neural networks is a harmonic oscillation, or the math performed by cortical neural networks emerges from this model. Emergent is defined as mathematical calculations performed by neural networks beyond the calculations performed by the individual neurons that comprise the network.

Harmonic oscillations are generally defined as:

ω=2πf

E=nhω

where ω denotes angular momentum, E denotes energy, h is the Planck constant, andf is frequency.

In biological neural networks, f may be defined as the frequency of harmonic oscillations initiated by FS neurons and w as activity in neural networks in space and time. Defining activity in terms of space as harmonic oscillations enables modeling the emergent calculations performed by cortical neural networks. In the preferred embodiment, the movement of space and time is related to the periodicity of harmonic oscillatory activity. This may include and is not limited to defining the movement of activity from thalamic input to reciprocal activation of FS neurons by excitatory neurons as one period.

In one aspect, activity in neural networks may be predicted by traditional models of physiological properties, including and not limited to modeling E using the Goldman-Katz equation. As would be known by one skilled in the art, q or flux is commonly used in modeling neural networks, not mass. Oscillatory activity then is charge or flux moving through space and time. As would be known by one skilled in the art, the calculations performed by neural networks may be modeled using myriad derivations of quantum physics.

In another aspect, balanced inhibition and excitation may be modeled using an artificial neural network or comparable form of AI.

In biological neural networks, FS neurons uniquely initiate high frequency oscillatory activity in the cortex due to their uniquely strong connectivity and rapid temporal properties; FS neurons are uniquely able to sustain high frequency firing, a property requisite for initiating high frequency synchronized oscillatory activity in neural networks. FS neurons are additionally electrically coupled to other FS neurons, forming a rapid gap junction coupled FS network. FS neurons uniquely express genes that enable initiating high frequency oscillatory activity.

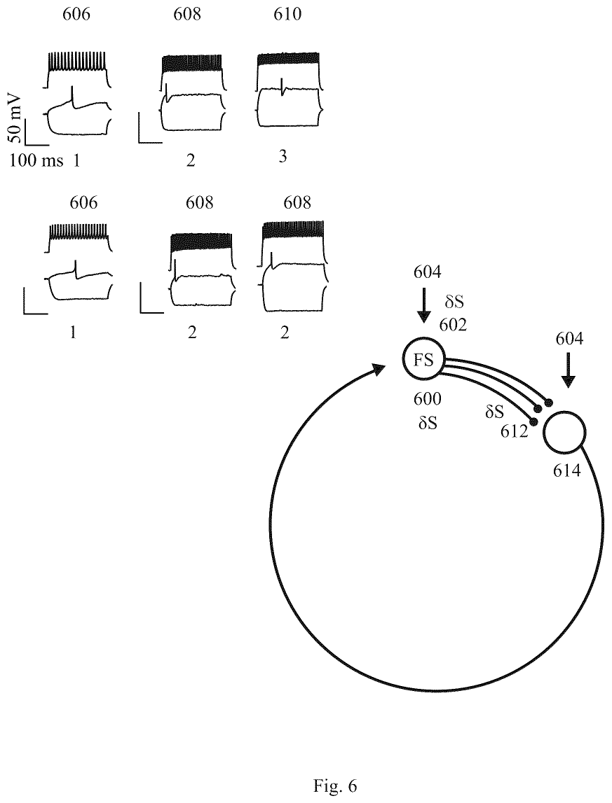

Cortical neural networks can rapidly remodel to myriad structures that reflect thalamic input, or experience, a biological process known as experience dependent plasticity. In reference to FIG. 6, a model of FS neurons regulating activity in space and time that includes FS neurons shifting between maturation states. As described previously, FS neurons 600 regulate experience dependent plasticity in neural networks by shifting between discrete maturation states 602 in response to thalamic input 604. Experience dependent plasticity in cortical neural networks was thought to be restricted to a short window during early development, however, it has been found that FS neurons may return to earlier states in adults. FS neurons shifting between maturation states underlies many forms of learning and memory, including the initiation of new neurons in hippocampus. FS neurons role as regulators enable FS neurons to regulate coordinated activity requisite to neural plasticity, including and not limited to experience dependent plasticity.

As described previously, the differential physiological properties of each state correspond to differing maturational ages. For simplicity, maturation states may be defined as state 1 606, state 2 608, and state 3 610. Maturational states are illustrated in this disclosure by representative images of physiological firing properties 606, 608, and 610, however, as would be known by one skilled in the art, myriad properties may be used. As described previously, experience dependent FS states were first described in the auditory cortex of mice, where experience dependent development of FS neurons corresponds to postnatal ages (p) 12-13 (state 1), p 17-18 (state 2), and postnatal ages above 21 (state 3), with transitions between maturation states occurring between p 14-16 and p 19-21. Experience is encoded into a neural network during transitional states, corresponding to FS neurons forming new connections and translating gene expression into functional properties. Identification of FS states may include and is not limited to the expression of the LHX homeobox protein 6, visual system homeobox 2, TGFB-induced factor homeobox 2, zinc finger homeodomain 4, zinc fingers and homeoboxes 1, which are upregulated in earlier FS maturation states, and homeobox C13 and distal-less homeobox 3 (Hoxc3), which are expressed in later maturation states. FS neurons express myriad glial and similar immune support cell maturation factors when shifting states. State shifts may be predicted in myriad ways, including and not limited to thalamic input, FS properties, loss of balanced excitation and inhibition, and the movement of activity in space and time.

In the model shown, inhibitory FS neurons regulate activity in space and time, and may change maturational states in relation to thalamic input 604. FS neurons retract and reform connections 604, 612 during transitions between maturation states, as varying states exhibit varying connectivity. This may be modeled as FS neurons reforming thalamic connections 604 and inhibitory connections 612 onto excitatory neurons 614. The complex connectivity of neural networks, or the structure and function, may be modeled by FS regulation of activity in space in time during state shifts.

In another aspect, thalamic input, or experience, may additionally be modeled as FS regulation of activity in space and time. This includes and is not limited to predicting the structure and function of a neural network formed in relation to experience relayed as thalamic input.

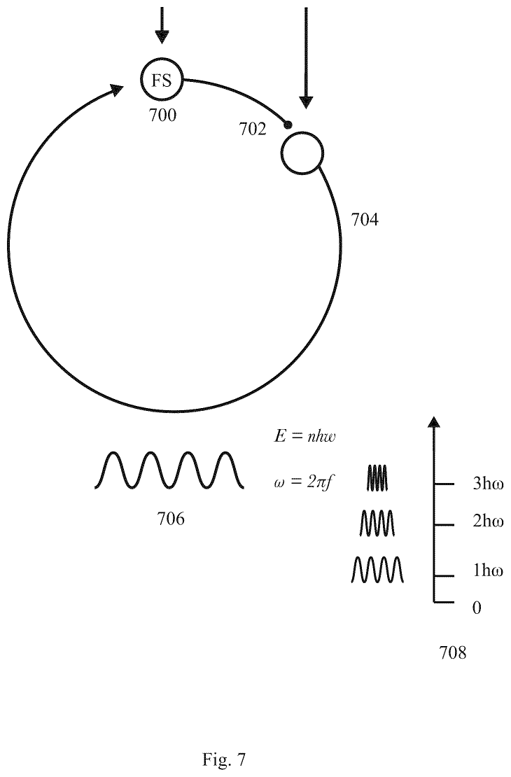

In reference to FIG. 7, FS neuron 700 regulated 702 activity in neural networks 704 may include the emergence of discrete oscillatory frequencies 706 that reflect discrete maturational states.

As described previously, activity as it moves through cortical space and time can be defined as:

\ddot{x}=ω²x=0.

In the model shown, inhibitory FS neurons regulate activity in space and time according to the following properties:
1. FS neurons are rare yet make significantly more connections with significantly greater weight;
2. FS neurons perform calculations in advance of regulated neurons and uniquely sustain high frequency firing rates;
   where changes in FS states maintain the approximate balance between FS mediated inhibition and excitation. As would be known by one skilled in the art, balanced inhibition and excitation may be modeled using physiological properties using myriad methods, including and not limited to using the Goldman-Katz equation to inhibition and excitation.

In another aspect, the emergent of harmonic oscillations corresponds to balanced inhibition and excitation; changes in FS states are reflected in changes in the frequency of harmonic oscillations 708.

In biological neural networks, changes in the frequency of oscillatory activity corresponds to changes in the connectivity and strength of FS mediated inhibition 702, or the spread of activity in cortical space and time 704. Synchronized activity emerges as FS neurons reform connections after shifting states. The balance of excitation and inhibition is retained in each state, however, the frequency of harmonic oscillations changes to reflect the corresponding shift in connectivity and maturation properties.

In another aspect, synchronized activity is requisite to synaptic plasticity. As described previously, FS neurons may regulate synaptic plasticity by coordinating the activity of neural networks in space and time, which may be defined by harmonic oscillatory activity initiated by FS neurons.

In another aspect, this model enables the connectivity, or the structure of neural networks to be related to the input, and further reduces this to FS mediated regulation of activity in space and time. The activity in space and time, and the harmonic oscillations emerging from this network model, reflect the input, which reflects the structure and function of the neural network. This model reduces complicated network dynamics in time and space to regulation of the network by FS neurons, which may include and is not limited to reducing network complicity to high frequency oscillatory activity.

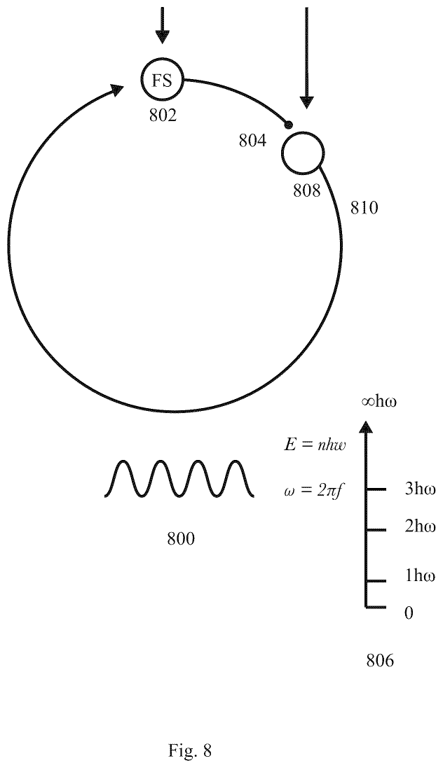

In reference to FIG. 8, this model enables understanding of the math performed in cortical neural networks that may be applied to disparate systems. The frequency of harmonic oscillatory activity 800 in space and time in relation to FS neuron 802 activity 804 in varying FS states may be defined as:

\ddot{x}=ω²x=0

ω=2πf

E=nhω, or E=hf

where n denotes the maturation state, co denotes angular momentum, E denotes energy, h is the Planck constant, and f is frequency. This is comparable to particle physics, wherein n denotes discrete energy states of particles. Modern physics contains myriad theories with basis harmonic oscillatory activity that are experimentally difficult to test, including and not limited to high energy particle physics and string theory. In this model, the frequency of harmonic oscillations may be easily determined by FS activity. Similarly, the position of activity as it moves through space and time may be easily determined.

In theory, energy may be infinite 806, as inhibition 802, 804 and excitation 808, 810 may be infinitely balanced, or the sum of both terms is equal to 0. This enables models of theoretical states, including and not limited to high energy particle physics, in an artificial neural network wherein FS mediated harmonic oscillations are an emergent property.

In another aspect, an artificial neural network with the known emergent of harmonic oscillations may be quantized and applied to quantum energy states. The model in this disclosure may be applied to predicting the frequency of quantum harmonic oscillators.

The model provides enables a general model for traditional models of neural network modeling, which may be modified for variability in networks and neural network math techniques, including and not limited to traditional and modern math models derived from quantum mechanics, which may include and is not limited to use of deep learning to solve equations. In the preferred embodiment, this model is used to make predictions and understanding neural networks by combining the model with deep learning, however, as would be known by one skilled in the art, this model may be used to infer meaning and reduce complexity in traditional methods of modeling neurons and probabilistic models of neural networks in full or in part.

Although the invention in this disclosure has been described with reference to specific embodiments, myriad modifications thereof will be apparent to one skilled in the art without departing from the spirit and scope of the invention.

What is claimed is:

1. A system of modeling activity in space and time in neural networks, comprising:
a plurality of neurons forming a neural network;
wherein a plurality of FS neurons and a plurality of excitatory neurons receive input;
a smaller number of FS neurons are connected to more neurons and with greater weight as compared to excitatory neurons;
wherein FS neurons inhibit a plurality of reciprocally connected excitatory neurons;
wherein excitation and inhibition are approximately balanced.

2. the model of claim 3 wherein FS neurons regulate activity in space and time.

3. the model of claim 2 wherein activity in space and time is defined as \ddot{x}=ω2x=0.

4. the model of claim 2 further comprising coordination of synaptic plasticity.

5. the model of claim 1 wherein harmonic oscillations are is known to emerge.

6. the model of claim 5 wherein a harmonic oscillator is a quantum harmonic oscillator.

7. the model of claim 5, wherein the model predicts high frequencies.

8. the model of claim 5 wherein FS neuron activity determines the frequency of harmonic oscillations.

9. A system of modeling changes in activity in space and time in neural networks, comprising:
a plurality of neurons forming a neural network;
wherein a plurality of FS neurons and a plurality of excitatory neurons receive input;
a smaller number of FS neurons are connected to more neurons and with greater weight as compared to excitatory neurons;
wherein FS neurons inhibit a plurality of reciprocally connected excitatory neurons;
wherein FS neurons may shift between discrete energy states;
wherein excitation and inhibition are approximately balanced in each state.

10. the model of claim 9 wherein changes in input determine FS state shifts.

11. the model in claim 9 wherein the structure and function reflects input received during FS state shifts.

12. the model in claim 11 wherein activity in space and time reflects input.

13. the model of claim 9 wherein FS states determine activity in space and time.

14. the model of claim 9 wherein harmonic oscillations emerge in each state.

15. the model of claim 14 wherein a harmonic oscillator is a quantum harmonic oscillator.

16. the model of claim 14 further comprising high, theoretically infinite, possible frequencies.

17. the model of claim 14 wherein FS activity determines the frequency of harmonic oscillations.

18. the model of claim 9 further comprising theoretically infinite inhibition and excitation.

19. the model of claim 9 wherein loss of balance during FS state shifts is a known property.

20. the model of claim 9 wherein loss of harmonic oscillations during FS state shifts is a known property.
